(19) United States
(12) Patent Application Publication
(10) Pub. No.: US 2016/0099555 A1
(43) Pub. Date: Apr. 7, 2016

(54) Universal Box Mounting Adapter and System

(71) Applicants: Saeed Nikayin, Los Angeles, CA (US); Kai Zhang, Los Angeles, CA (US); Gilbert Loera, Los Angeles, CA (US)

(72) Inventors: Saeed Nikayin, Los Angeles, CA (US); Kai Zhang, Los Angeles, CA (US); Gilbert Loera, Los Angeles, CA (US)

(21) Appl. No.: 14/507,364

(22) Filed: Oct. 6, 2014

(51) Int. Cl. H02G 3/12; H02G 3/14; H02G 3/08; F16L 3/13; F16L 3/137

(52) U.S. Cl. CPC H02G 3/121; F16L 3/13; F16L 3/137; H02G 3/083; H02G 3/14

(57) ABSTRACT

Improvements in a universal box mounting adapter and system for mounting 4″ and 4 11/16″ boxes directly to stud using side tabs. In addition, the UBM features a bendable back support for rigid installations. The novel feature of this product is the integral conduit support flange. This flange features slots and pinholes for use with a wide assortment of conduit supporting accessories. The adapter can be used with a kick bracket for placing junction boxes between studs at desired heights. The kick bracket can be mounted either vertically or horizontally and features pinholes along the length for adjusting the location of the adapter. Along with integral wings for supporting the kick bracket when installed vertically, the adapter and kick bracket make up a system of configurations to meet the needs of an installer. The adapter is configurable for installing multiple boxes between either 16″ or 24″ studs.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a universal box mounting adapter and system. More particularly, the present universal box mounting adapter is an adapter for mounting 4″ and 4 11/16″ electrical boxes directly to studs using side tabs. The universal box mounting adapter further includes bendable back supports and integral conduit support flanges.

Description of Related Art including information disclosed under 37 CFR 1.97 and 1.98:

Houses and buildings require connection of electricity to operate light appliances and equipment. To connect these devices an installer uses electric boxes that are mounted upon. Walls are generally formed against wooden or metal studs, although metal of a channel configuration is particularly common in modern residential and commercial applications. In such applications, electric boxes tend to be supported by assemblies, frames or brackets that are in turn mounted to the metal studs or to other components that rest directly on the floor.

Electric boxes are supported in many fashions within the walls on supporting studs. The electrical boxes may be fastened directly to a wall stud, albeit this method is generally discouraged on metal studs for practical reasons. The electrical boxes may rest within a bracket that attaches along one side to a vertical wall stud. Traditional methods of mounting such electric boxes therefore require electricians or the like to maintain a complete stock of each type of mounting bracket that may be necessary as the situation demands.

There are a number of patents and or publications have been made to address these issues. Exemplary examples of patents and or publication that try to address this/these problem(s) are identified and discussed below.

U.S. Pat. No. 4,964,525 issued on Oct. 23, 1990 to Donald T. Coffey et al., discloses an Electrical Box Mounting Bracket. This bracket is configured to grasp a side stud or can span across two studs if the studs a spaced close enough together. This patent is only configured for a single electrical box, and does not include a system for securing multiple junction boxes, it further does not provide support for conduit and does not includes pin holes for multiple mounting configurations.

U.S. Pat. No. 7,439,443 issued on Oct. 21, 2008 to Cong Thanh Dinh discloses a Mounting Bracket for Electrical Boxes. The bracket can universally be secured to a stud wall with both front and side holes for nailing or screwing the bracket to the stud. This bracket has limited versatility to accept conduit or other mounting accessories. These limitations provide limited options for an installer to mount the bracket in different configurations to studs.

U.S. Pat. No. 8,403,289 issued on Mar. 26, 2013 to Eric R. Rinderer discloses a Universal Electrical Box Mounting Device. This mounting system is predominately configured for mounting of a single adapter to metal stud walls. If multiple adapters are used the multiple adapters are first secured to separate strip that is secured to the metal studs. While some configurations have an enlarged hole for a conduit, the opening does not securely hold the conduit to prevent undesirable movement of the conduit within the opening. The mounting device further requires a separate strip to mount an electrical box between stud walls.

What is needed is a universal box mounting adapter and system. Disclosure found in this document provides a solution with an adapter for mounting 4″ and 4 11/16″ boxes directly to studs using side tabs.

### BRIEF SUMMARY OF THE INVENTION

It is an object of the universal box mounting adapter and system to mount 4″ and 4 11/16″ boxes directly to studs. The side tabs include a plurality of holes where screws can be inserted for securing the universal box mounting adapter onto wood or metal studs. When the universal box mounting adapter is secured it provides a stable base for connecting an electrical junction box behind the universal box mounting adapter and also provide a mounting front for a finish plate where drywall, sheetrock or similar sheet material can be used for the finished wall surface. The front plate has keyholes for accommodating 4S and 5S boxes.

It is an object of the universal box mounting adapter and system to include an integral conduit support flange. The integral conduit support flange maintains the position of rigid conduit as the rigid conduit connects to the universal box mounting adapter. The support allows an installer to secure a variety of different accessories to the universal box mounting adapter to accommodate conduit securing devices such a tie wire, one-hole straps, conduit clips, Colorado jim clips, zip ties and bat wings.

It is an object of the universal box mounting adapter and system for the integral conduit support flange to have slots and pinholes for use with a wide assortment of conduit supporting accessories.

It is another object of the universal box mounting adapter and system to operate with a universal box mounting adapter kick bracket for placing junction boxes between studs at a desired height. The kick bracket provides horizontal and vertical installations as well as versatile positioning of the universal box mounting adapter system.

It is another object of the universal box mounting adapter and system to allow for mounting in either a vertical or a horizontal orientation. Features pinholes along the length for adjusting the location of the universal box mounting adapter.

It is still another object of the universal box mounting adapter and system to have integral wings for supporting the kick bracket when installed in a vertical orientation, the universal box mounting adapter and kick bracket make up a system of configurations to meet the needs of an installer.

It is still another object of the universal box mounting adapter and system to operate with 16″ or 24″ on center studs. Building and houses are usually constructed with studs placed 16″ or 24″ on center and electrical outlets can be adjacent to the studs or placed between the studs. The universal box mounting adapter can further be configures to accept multiple junction boxes between the studs. A floor stand can also be used to set the universal box mounting adapter 15″ or 18″ from the floor.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the universal box mounting adapter and system.

FIG. 2A-2B shows perspective views of the universal box mounting adapter kick bracket.

FIG. 3A-3D show perspective views installation of a single universal box mounting adapter.

FIG. 4A-4D show perspective views installation of two universal box mounting adapter.

FIG. 5A-5B show perspective views of a triple universal box mounting adapter on a floor stand and an extender with a conduit hook.

FIG. 6A-6D show perspective views installation of a triple universal box mounting adapter.

FIG. 7 shows a perspective view of a four position universal box mounting adapter.

FIG. 8A-8E show perspective views of different conduit supporting options.

FIG. 9 shows a perspective view of a universal box mounting adapter installed on a metal stud with secured conduit.

### DETAILED DESCRIPTION OF THE INVENTION

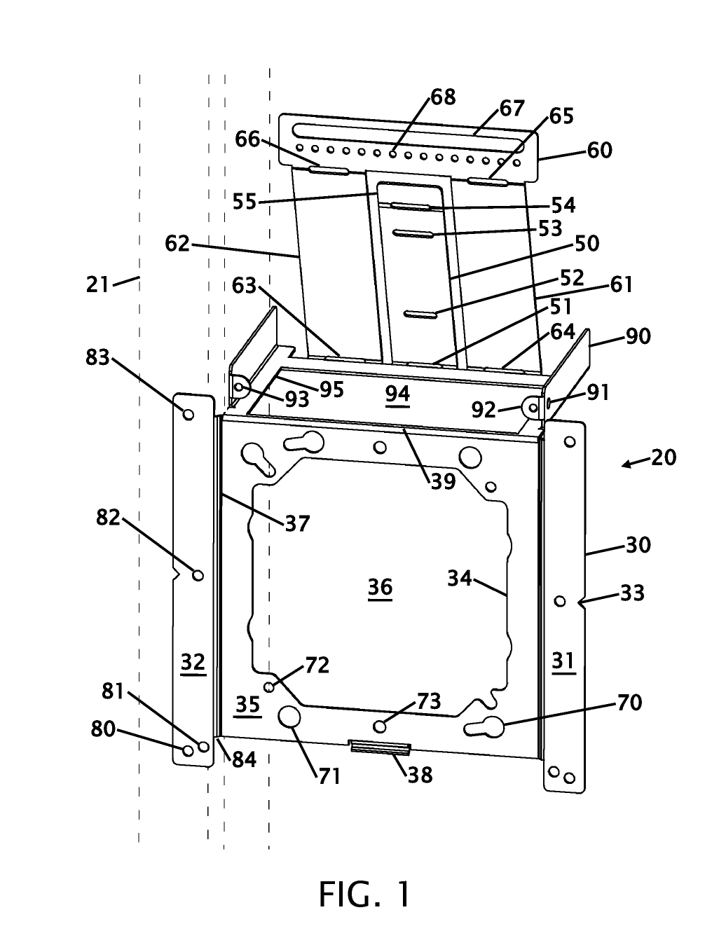

FIG. 1 shows a perspective view of the universal box mounting adapter 20 and system secured to a stud 21. The stud can be either a wood or metal stud for 4″ or 6″ thick wall. The front mounting flanges 31 and 32 face of the universal box mounting adapter 20. These mounting flanges 31 and 32 have a plurality of holes 80, 81, 82, 83. The holes 80, 81, 82, and 83 allow for mounting the universal box mounting adapter 20 directly on to a stud. The front mounting flanges 31 and 32 have a notch 33 to identify the center line of the universal box mounting adapter 20 on the flange(s) 30. Relief bends 37 recess face 35 and provide clearance for securing hardware for an electrical box cover (not shown).

The center of the universal box mounting adapter 20 is open 36 within the boundary 34 for access to wiring within the universal box mounting adapter 20. This face 35, has a plurality of mounting holes 71, 72, 73 and keyhole slots 70 for securing an electrical box cover. The bottom of the face 35 has a tab 38. The face 35 bends 39 to an open 94 horizontal support 95.

The horizontal support 95 has vertical sides 90 and front-facing tabs 92 with mounting or securing holes 93. The vertical sides 90 also have holes 91 for securing our mounting the universal box mounting adapter 20. The holes 91 can be used to screw the universal box mounting adapter 20 into the side of a stud 21. The center 94 of the horizontal support 95 is open. The back of the horizontal support has central tab 50 and two joined tabs 61 and 62.

The central tab 50 is secured to the horizontal support 95 with an open hinge 51. The open hinge allows the central tab 50 to easily bend on the horizontal support 95. The central tab 50 further includes a plurality of open slots 52, 53 and 54 that allows the central tab 50 to be easily bent at these locations without special tools. The central tab 50 can be bent back horizontally and further bent at slot 53 to fit within a 6-inch stud wall where the end portion 55 is oriented vertically. The central tab 50 is an adjustable back support.

The two joined tabs 61 and 62 are secured to the horizontal support 95 with open hinges 63 and 64. These two joined tabs 61 and 62 are joined at the top through tab 60 that promotes uniform bending of tabs 61 and 62. Tab 60 joins to the tabs 61 and 62 through open hinges 65 and 66 that promote uniform bending of the top tab 60. The top tab 60 provides a plurality of holes 68 and a slot 67 for a plurality of conduit supporting options as shown and described in FIGS. 8A-8E.

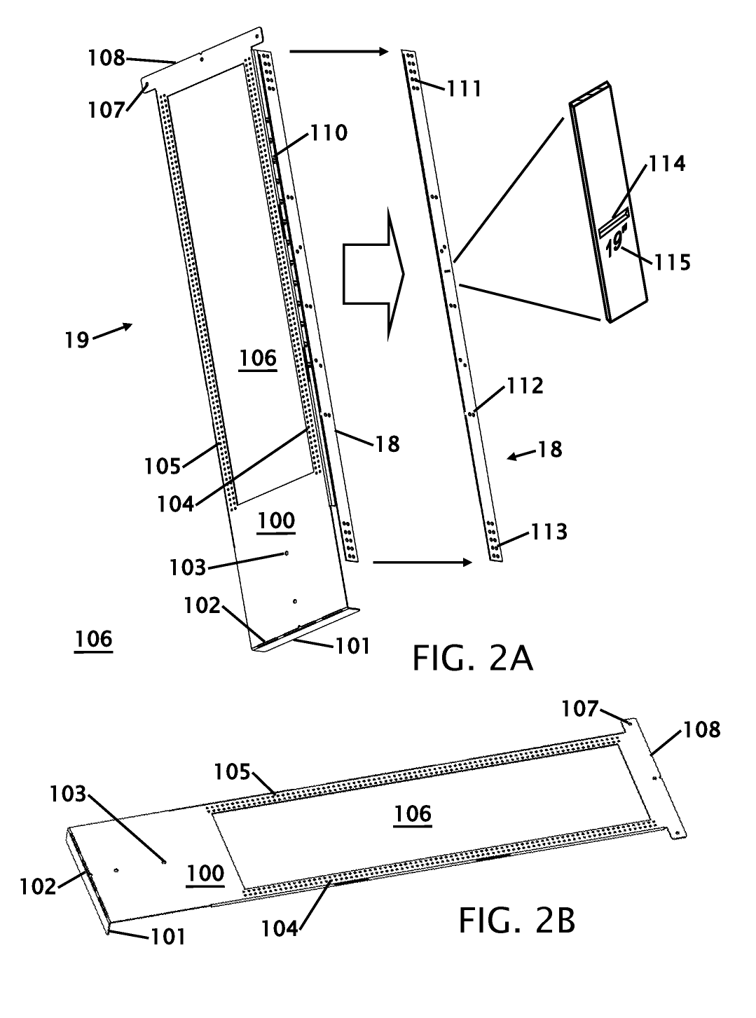

FIG. 2A-2B shows perspective views of the universal box mounting adapter kick bracket 19. The kick bracket 19 allows the universal box mounting adapter 20 to be secured between studs and further can be installed in either a vertical orientation as in FIG. 2A or a horizontal orientation and in FIG. 2B. The kick bracket 19 has a support face 100 and an open area 104 where one or more universal box mounting adapter 20 are installed. The kick bracket 19 has a bent tab 101 that is bent 102 along a weakened area(s) 102 of the face 100. The bent tab 101 can be placed under or around a stud or footer. The kick bracket 19 has a plurality of pin holes 104 and 105 that provide multiple securing locations for the kick bracket 109. Holes 103 and 107 are used to secure the kick bracket 19 to footers, studs and or fire breaks. The top of the kick bracket 19 has extended tabs to extend beyond the body of the face to secure the kick bracket 19 to studs that exist outside the face 100. On the side of the kick bracket 19 a breakable wing 18 can be removed from the lick bracket 19 to provide orthogonal support to the kick bracket 19 and the universal box mounting adapter 20.

The breakable wing 18 has a plurality of pin holes 111 and 113 for securing the breakable wing 18 to stud walls and a plurality of other holes 112 for securing the universal box mounting adapter 20 or for securing the breakable wing 18 to a stud. The breakable wing 18 further has imprints 14 or indicia 115 for consistent box placement of the universal box mounting adapter 20. A number different installation options are possible for mounting a single or two universal box mounting adapter(s) 20.

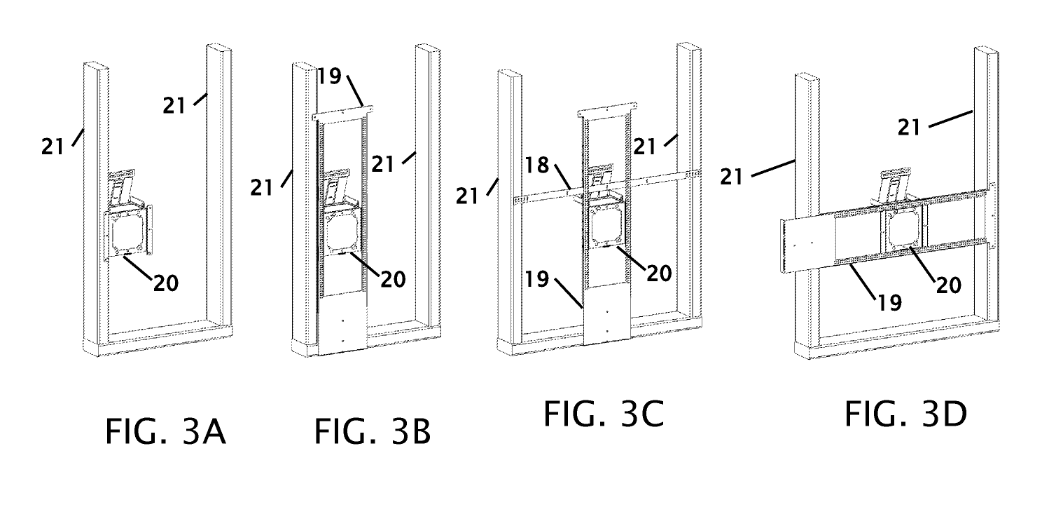

FIG. 3A-3D show perspective views installation of a single universal box mounting adapter. FIG. 3A shows the universal box mounting adapter 20 mounted to a vertical stud 21. FIG. 3B shows a universal box mounting adapter 20 secured to a vertical kick bracket 19 and the kick bracket 19 secured to a vertical stud 21 and to a footer. FIG. 3C shows a universal box mounting adapter 20 mounted to a vertical kick bracket 19. The vertical kick bracket 18 is secured with a wing 18 between two vertical studs 21 and a footer. FIG. 3D shows a universal box mounting adapter 20 secured to a horizontal kick bracket 19 and the horizontal kick bracket is secured to two vertical studs 21.

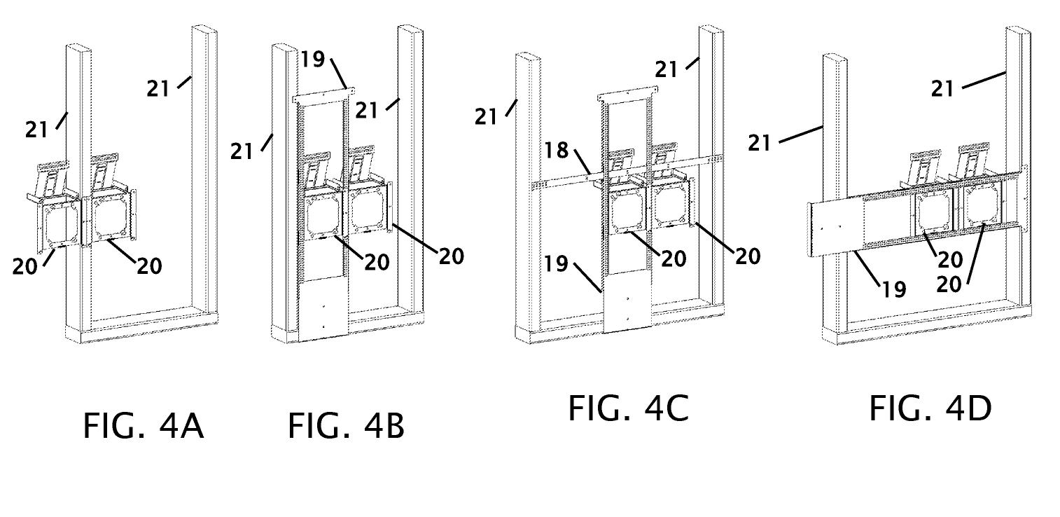

FIG. 4A-4D show perspective views installation of two universal box mounting adapter. FIG. 4A shows two universal box mounting adapters 20 mounted to a vertical stud 21. FIG. 4B shows two universal box mounting adapters 20 secured to a vertical kick bracket 19 and the kick bracket 19 secured to a vertical stud 21 and to a footer. FIG. 4C shows two universal box mounting adapters 20 mounted to a vertical kick bracket 19. The vertical kick bracket 18 is secured with a wing 18 between two vertical studs 21 and a footer. FIG. 4D shows two universal box mounting adapters 20 secured to a horizontal kick bracket 19 and the horizontal kick bracket is secured to two vertical studs 21.

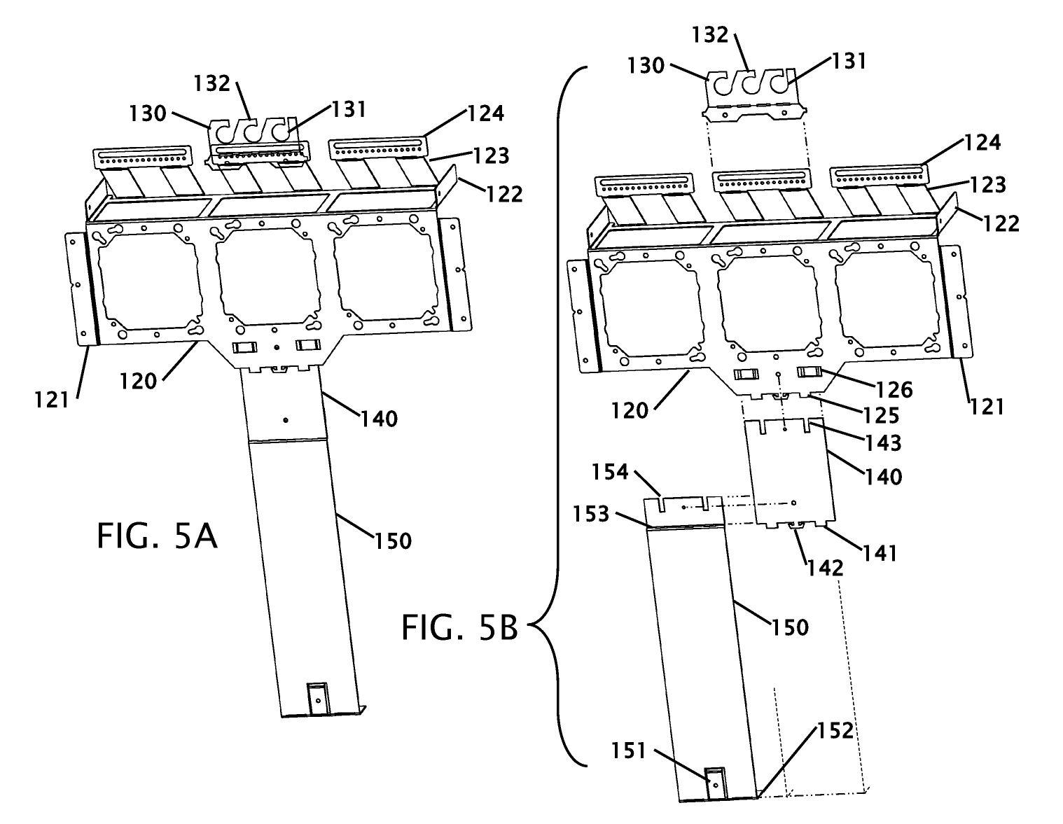

FIG. 5A-5B show perspective views of a triple universal box mounting adapter 120 on a floor stand 150 and an extender 140 with a conduit hook 130. The triple universal box mounting adapter 120 allows an installer to use a single plate for three junction boxes. The triple universal box mounting adapter 120 has similar features to the single universal box mounting adapter 20 previously described. This triple universal box mounting adapter 120 has side ears 121, with vertical sides 122, tabs 123 and top tab 124. In these figures a conduit clip 130 is securable to the top tab 124. The conduit clip 130 has multiple holes 131 with bendable tabs 132 that can be bend to retain conduit.

The triple universal box mounting adapter 120 can be connected to an extender 140 by securing the extender 140 with tabs 125, 126 and 140. A screw locks the parts together. The extender 140 is securable to the floor stand with tabs 141, 142, and 154. A bend 153 allows the front of the extender 140 and the floor stand 150 to be essentially parallel. While an extender 140 is shown, none or multiple extenders can be used. The bottom of the floor stand 150 has a bottom bend 152 and a hole to secure the floor stand 150 to a stud.

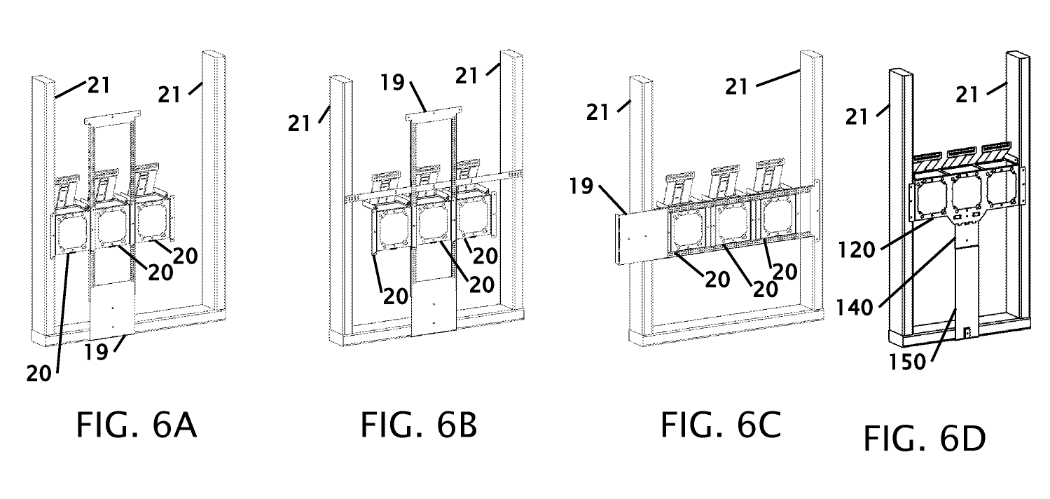

FIG. 6A-6D show perspective views installation of a triple or three universal box mounting adapter. FIG. 6A shows three universal box mounting adapters 20 mounted to a vertical stud 21 with a kick bracket 19. FIG. 6B shows three universal box mounting adapters 20 secured to a vertical kick bracket 19 and the kick bracket 19 secured to a footer. FIG. 6C shows three universal box mounting adapters 20 mounted to a horizontal kick bracket 19. The horizontal kick bracket 19 is secured between two vertical studs 21. FIG. 6D shows a triple universal box mounting adapter 120 secured to an extender 140 on a floor stand 150. The triple universal box mounting adapter 120 is shown secured between two studs 21.

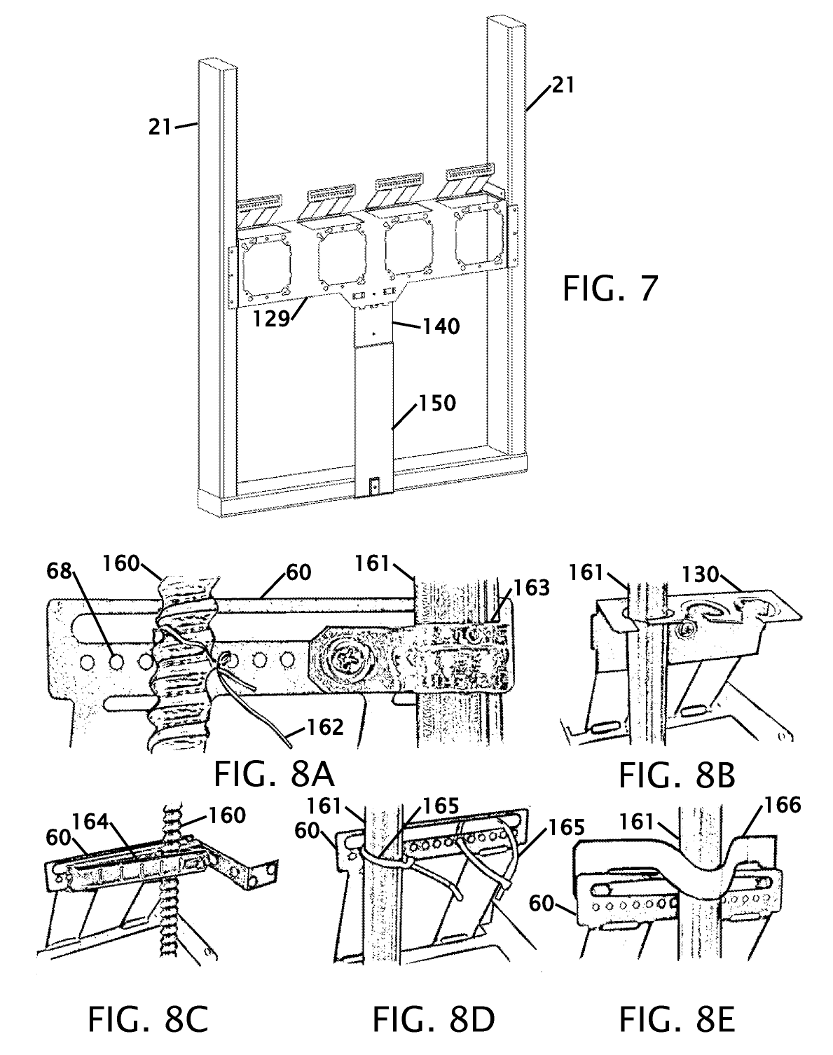

FIG. 7 shows a perspective view of a four position universal box mounting adapter 129. The four position universal box mounting adapter 129 allows an installer to use a single plate for four junction boxes. The quadruple universal box mounting adapter 129 has similar features to the single and triple universal box mounting adapters 20 and 120 respectively previously described. In this figure, the four position universal box mounting adapter 129 is shown mounted between two studs 21 secured to an extender 140 on a floor stand 150. The floor stand 150 offers a height of 15″ when installed without the extender 140 and a height of 18″ with a single extender 140.

FIG. 8A-8E show perspective views of different conduit supporting options on the securing tab 60. FIG. 8A shows a flexible conduit 160 secured with tie wire 162 to the tab 60 and a rigid conduit 161 secured to the tab 60 with a one-hole strap 163 with a screw securing the one-hole strap to a hole in the securing tab 60. FIG. 8B shows a rigid conduit 161 secured with the conduit clip 130. FIG. 8C shows flexible conduit 160 secured with a Colorado Jim 164 conduit connector. FIG. 8D shows ridged conduit 161 secured to tab 60 using zip ties 165. FIG. 8E shows a ridged conduit 161 secured to the tab 60 with Bat Wings clip 166.

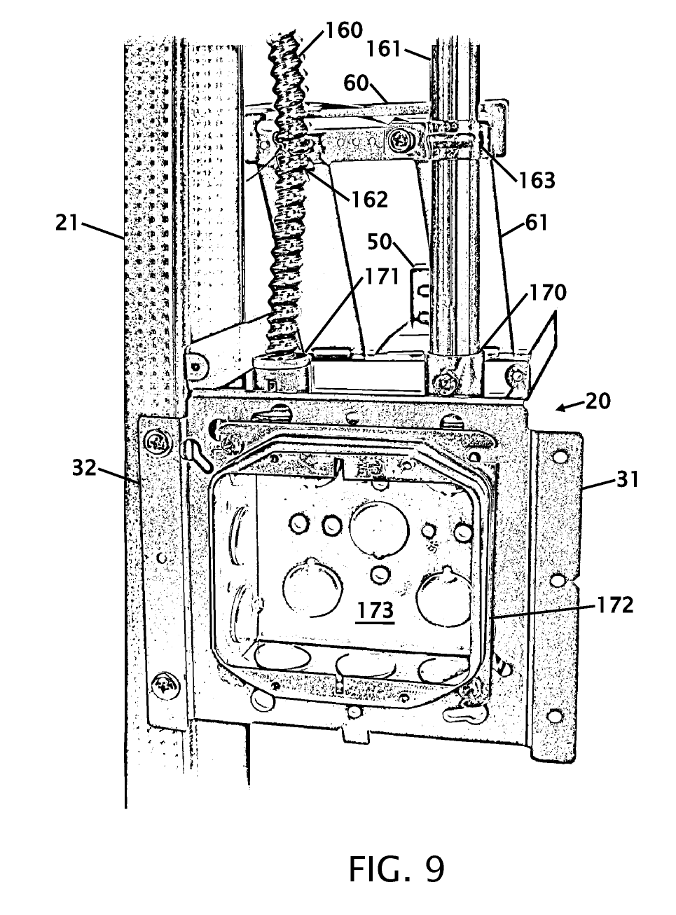

FIG. 9 shows a perspective view of a universal box mounting adapter 20 installed on a metal stud 21 with secured flexible conduit 160 and rigid conduit 161. The universal box mounting adapter 20 is shown with a front electrical box cover 172 and an electrical box 173 installed onto the universal box mounting adapter 20 where the front mounting flange 32 of the universal box mounting adapter 20 is secured to stud 21 and the other front mounting flange 31 is free. A conduit adapter 170 transitions from the rigid conduit 160 to the top of the junction box 173. The ridged conduit 161 is secured with a one-hole strap 163 to the horizontal tab 60. A conduit adapter 171 transitions from the flexible conduit 162 to the top of the junction box 173. The flexible conduit 162 is secured with a tie wire 162 to the horizontal tab 60. In this figure the central tab 50 is bent to provide a back support to the universal box mounting adapter 20.

Thus, specific embodiments of a universal box mounting adapter and system have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A universal box mounting adapter and system comprising:
a plurality of front mounting flanges;
said plurality of front mounting flanges having a plurality of holes for mounting said universal box mounting adapter to a stud;
each of said plurality of front mounting flanges having an offset bend to a recessed face that joins said plurality of front mounting flanges;
said recessed face having a central opening;
said recessed face further having a plurality of mounting holes, slots and keyways;
said recessed face having a horizontal support;
said horizontal support having vertical sides;
said vertical side each having front-facing tabs;
said horizontal support having a central tab bent from said horizontal support;
said horizontal support further having two joined tabs that are secured to said horizontal support;
said two joined tabs being joined through a horizontal tab that promotes uniform bending of said two joined tabs;
said horizontal tab having a plurality of holes and at least one slot for securing a conduit.

2. The universal box mounting adapter and system according to claim 1 wherein said front mounting flanges have at least one notch to identify a center line of the universal box mounting adapter.

3. The universal box mounting adapter and system according to claim 1 wherein said recessed face has at least one relief bend.

4. The universal box mounting adapter and system according to claim 1 wherein said recessed face is recessed to provide clearance for securing hardware of an electrical box cover.

5. The universal box mounting adapter and system according to claim 1 wherein said center of said universal box mounting adapter is open.

6. The universal box mounting adapter and system according to claim 5 wherein said open center provides access to wiring placed within said universal box mounting adapter.

7. The universal box mounting adapter and system according to claim 1 wherein said universal box mounting adapter has a plurality of holes, slots and keyways to secure an electrical box cover.

8. The universal box mounting adapter and system according to claim 1 wherein said face has a tab.

9. The universal box mounting adapter and system according to claim 1 wherein said central tab includes a plurality of open slots that allows said central tab to be easily bent.

10. The universal box mounting adapter and system according to claim 1 wherein said central tab provides a back support for said universal box mounting adapter.

11. The universal box mounting adapter and system according to claim 1 wherein said universal box mounting adapter is formed from a single sheet of material.

12. The universal box mounting adapter and system according to claim 1 further includes a floor stand.

13. The universal box mounting adapter and system according to claim 12 further includes at least one extender.

14. The universal box mounting adapter and system according to claim 1 further includes a kick bracket.

15. The universal box mounting adapter and system according to claim 14 wherein said kick bracket has a breakable wing wherein said breakable wing is separable from said kick bracket.

16. The universal box mounting adapter and system according to claim 14 wherein said kick bracket provides mounting for at least two universal box mounting adapters.

17. The universal box mounting adapter and system according to claim 14 wherein said kick bracket is mountable to studs in a vertical or a horizontal orientation.

18. The universal box mounting adapter and system according to claim 1 further includes a conduit clip.

19. The universal box mounting adapter and system according to claim 1 wherein said horizontal tab provides conduit to be secured with at least one of a group consisting of a tie wire, a one-hole strap, a conduit clip, a Colorado Jim, a zip tie and a Bat Wings clip.

20. A universal box mounting adapter and system comprising:
a plurality of front mounting flanges;
said plurality of front mounting flanges having a plurality of holes for mounting said universal box mounting adapter to a stud;
each of said plurality of front mounting flanges having an offset bend to a recessed face that joins said plurality of front mounting flanges;
said recessed face having at least two central opening;
said recessed face further having a plurality of mounting holes, slots and keyways;
said recessed face having a horizontal support;
said horizontal support having joined tabs that are secured to said front support;
said joined tabs being joined through separate horizontal tabs that promotes uniform bending of said joined tabs, and
said horizontal tabs having a plurality of holes and at least one slot for securing a conduit.
